(19) United States
(12) Patent Application Publication
(10) Pub. No.: US 2026/0150816 A1
(43) Pub. Date: Jun. 4, 2026

(54) HIGH-THROUGHPUT AND ACCURATE PHENOTYPE MEASUREMENT SYSTEMS AND METHODS FOR SHELLFISH

(71) Applicant: OCEAN UNIVERSITY OF CHINA, Qingdao (CN)

(72) Inventors: Xiaoli HU, Qingdao (CN); Xiangfu KONG, Qingdao (CN); Yujue WANG, Qingdao (CN); Shanhuan HUANG, Qingdao (CN); Haoying LIANG, Qingdao (CN); Chen HU, Qingdao (CN); Zhenmin BAO, Qingdao (CN)

(73) Assignee: OCEAN UNIVERSITY OF CHINA, Qingdao (CN)

(21) Appl. No.: 19/181,324

(22) Filed: Apr. 16, 2025

(30) Foreign Application Priority Data
Dec. 2, 2024 (CN) 202411751611.X

(51) Int. Cl. A01K 61/90

(52) U.S. Cl. CPC A01K 61/90

(57) ABSTRACT

The present disclosure relates to a high-throughput and accurate phenotype measurement system for shellfish, comprising a body size measurement unit, a dynamic weighing unit, an information acquisition unit, an automatic sorting unit, and an intelligent control unit arranged in sequence. The body size measurement unit is configured to measure a body size of a shellfish individual, the dynamic weighing unit is configured to measure a weight of the shellfish individual, the automatic sorting unit is configured to sort and collect the shellfish individual based on a trait measurement value, the information acquisition unit is configured to capture and record sample information of a candidate parent, and the intelligent control unit is configured to control the body size measurement unit, the dynamic weighing unit, the automatic sorting unit, and the information acquisition unit.

### CROSS REFERENCE TO RELATED APPLICATIONS

The present disclosure claims priority to Chinese patent application No. 202411751611.X, filed on Dec. 2, 2024, the entire contents of which are incorporated herein by reference.

### TECHNICAL FIELD

The present disclosure relates to the field of phenotype measurement for shellfish and selective breeding, and in particular, to a high-throughput and accurate phenotype measurement system and method for shellfish.

### BACKGROUND

As a major aquaculture country, marine aquaculture production in China accounts for approximately two-thirds of the total global aquaculture production. In particular, shellfish aquaculture accounts for about 70% of China's total marine aquaculture production, making it an important component of marine aquaculture. The breeding of fast-growing, high-yielding, and high-quality shellfish strains is of significant importance for promoting the sustained development of the shellfish farming industry. Large-scale and high-precision phenotype measurement and genotype analysis are key to accurately identifying candidate parents and also are the foundation for successful selective breeding. With the rapid development and significant cost reduction of next-generation sequencing and genotyping technologies, genetic testing has become more economical and accurate, gaining widespread use in aquaculture breeding. However, current phenotype measurement methods, due to their high labor intensity and insufficient accuracy, have become a bottleneck restricting the progress of precision breeding.

Some phenotype measurement technologies have been widely applied in the fields of plants and livestock, but they are still in the early stages of marine aquaculture. Furthermore, these technologies often demonstrate strong specificity for measuring different species and traits, with limited versatility. Currently, the phenotype measurement of aquaculture species, such as growth traits, mainly relies on manual measurement tools, such as vernier calipers and electronic scales. However, this method requires significant labor and time costs and is easily influenced by subjective factors, resulting in lower measurement accuracy. Additionally, sorting and labeling candidate parents based on phenotype data is also a crucial step in selective breeding. However, this process is primarily manual and prone to human error, which can reduce selection accuracy.

Therefore, there is a need to provide a high-throughput and accurate phenotype measurement system and method for shellfish to achieve rapid and accurate measurement of growth traits, efficient sorting of candidate parents, and collection of individual information, thereby enhancing the accuracy and efficiency of selective breeding of shellfish.

### SUMMARY

One or more embodiments of the present disclosure provide a high-throughput and accurate phenotype measurement system for shellfish. The system comprises a body size measurement unit, a dynamic weighing unit, an information acquisition unit, an automatic sorting unit, and an intelligent control unit arranged in sequence. The body size measurement unit is configured to measure a body size of a shellfish individual, the dynamic weighing unit is configured to measure a weight of the shellfish individual, the automatic sorting unit is configured to sort and collect the shellfish individual based on an acquired trait measurement value, the information acquisition unit is configured to capture and record sample information of a candidate parent, and the intelligent control unit is configured to control the body size measurement unit, the dynamic weighing unit, the automatic sorting unit, and the information acquisition unit.

One or more embodiments of the present disclosure provide a high-throughput and accurate phenotype measurement method for shellfish. The method is performed based on an intelligent control unit of a high-throughput and accurate phenotype measurement system for shellfish. The method comprises: controlling a conveyor belt to transfer a shellfish individual to a body size measurement unit from an input end of a first conveyor, controlling a first through-beam photoelectric sensor and a first encoder to detect a position and speed information of the shellfish individual and sending the position and the speed information to a three-dimensional laser scanner, controlling the three-dimensional laser scanner to initiate scanning of the shellfish individual, and transmitting image data obtained by the three-dimensional laser scanner to the intelligent control unit to determine a trait value of the shellfish individual based on the image data; after completion of individual trait measurement, transferring the shellfish individual to a dynamic weighing unit, when the shellfish individual passing through a second conveyor, controlling the dynamic weighing unit to convert a pressure signal into a high-level signal and transmitting the high-level signal to the intelligent control unit to determine a weight of the shellfish individual; when transferring the shellfish individual to an information acquisition unit using a third conveyor, scanning and identifying an identification label affixed to a surface of the shellfish individual using a barcode scanner, reading sample information, and automatically entering the trait value and the weight of the shellfish individual into the corresponding identification label at the same time; after the shellfish individual entering an automatic sorting unit, controlling the automatic sorting unit to determine a target individual by comparing with a preset grading standard based on a body size or the weight of the shellfish individual, controlling a first air pump, a second air pump, and a third air pump to drive a first pusher, a second pusher, and a third pusher to extend and retract, respectively, and push the target individual to a discharge chute of a corresponding grade, and completing sorting of a candidate parent; and collecting data of each unit and summarizing, integrating, recording, calculating, and storing the data of each unit.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a schematic diagram illustrating an overall structure of a high-throughput and accurate phenotype measurement system for shellfish according to some embodiments of the present disclosure;

FIG. 2 is a schematic diagram illustrating a top-view of a high-throughput and accurate phenotype measurement system for shellfish according to some embodiments of the present disclosure;

FIG. 3 is a schematic diagram illustrating a portion of structures of a body size measurement unit and an information acquisition unit according to some embodiments of the present disclosure;

FIG. 4 is a schematic diagram illustrating exemplary structures of a vibration-absorbing device and adjacent parts according to some embodiments of the present disclosure;

FIG. 5 is a schematic diagram illustrating a first conveyor according to some embodiments of the present disclosure;

FIG. 6 is a flowchart illustrating a process of a high-throughput and accurate phenotype measurement method for shellfish according to some embodiments of the present disclosure;

FIG. 7 is a schematic diagram illustrating data measurement and analysis of a body size measurement unit according to some embodiments of the present disclosure, wherein image A represents a black-and-white depth map of a chlamys farreri scanned using a body size measurement unit, and image B to image D are schematic diagrams illustrating regression analysis of shell height, shell length, and shell width obtained using a body size measurement unit and a vernier caliper, and image E to image G are schematic diagrams illustrating measurement errors of a single sample measured multiple times under different measurement methods for shell height, shell length, and shell width;

FIG. 8 is a schematic diagram illustrating data measurement and analysis of a dynamic weighing unit according to some embodiments of the present disclosure, wherein image A to image C are schematic diagrams illustrating regression analysis of body weights obtained using a dynamic weighing unit and an electronic balance, and image D to image F are schematic diagrams illustrating the accuracy of weight measurement of chlamys farreri, mizuhopecten yessoensism, and crassostrea gigas at different transfer speeds;

FIG. 9 is a schematic diagram illustrating individual labeling and sample information acquisition based on barcode technology according to some embodiments of the present disclosure;

FIG. 10 is a schematic diagram illustrating a retention ratio of scallop labels from which label information can be normally collected after 3 or 6 months of offshore farming according to some embodiments of the present disclosure;

FIG. 11 is a schematic diagram illustrating a display page of an intelligent control unit according to some embodiments of the present disclosure;

FIG. 12 is a schematic diagram illustrating a comparison of work efficiency between a phenotype measurement system for shellfish and a manual measurement method according to some embodiments of the present disclosure, wherein image A to image E respectively represent a comparison of time consumption between a body size measurement unit, a dynamic weighing unit, an automatic sorting unit, an information acquisition unit, and an intelligent control unit and the manual measurement method; and

FIG. 13 is a schematic diagram illustrating an exemplary shellfish identification model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

As used herein, “system,” “device,” “unit” and/or “module” are used as a way to distinguish between different levels of components, parts, sections, or assemblies at different levels. However, the words may be replaced by other expressions if other words accomplish the same purpose.

As shown in the present disclosure, unless the context clearly suggests an exception, the words “a,” “an,” “one,” and/or “the” do not refer specifically to the singular, but may also include the plural. Generally, the terms “including” and “comprising” suggest only the inclusion of clearly identified steps and elements that do not constitute an exclusive list, and the method or apparatus may also include other steps or elements.

The selection and breeding of fast-growing, high-quality, high-yield shellfish strains is key to promoting the sustained development of the shellfish farming industry. Accurate and efficient phenotype measurement is a prerequisite for precise strain breeding and trait analysis. Some embodiments of the present disclosure provide a high-throughput and accurate phenotype measurement system and method for shellfish, achieving high precision, high throughput, and standardized measurement of shellfish phenotypes. The system and method disclosed herein also has functions of candidate parent selection and sample information acquisition, providing reliable technical means for large-scale, precise, and selective breeding in shellfish. The following further elaborates and explains the present invention with reference to the accompanying drawings and specific embodiments, but the scope of the invention is not limited to these.

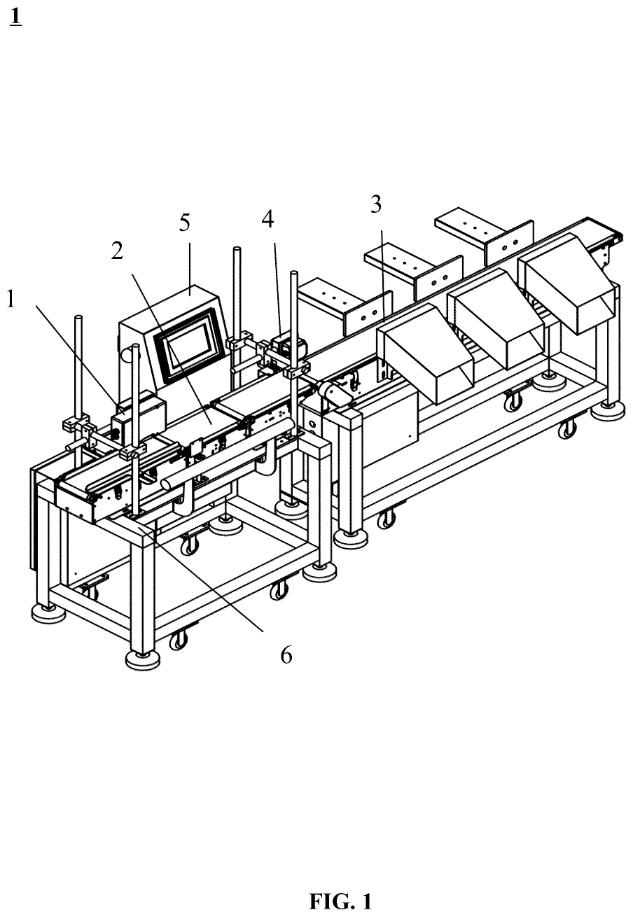

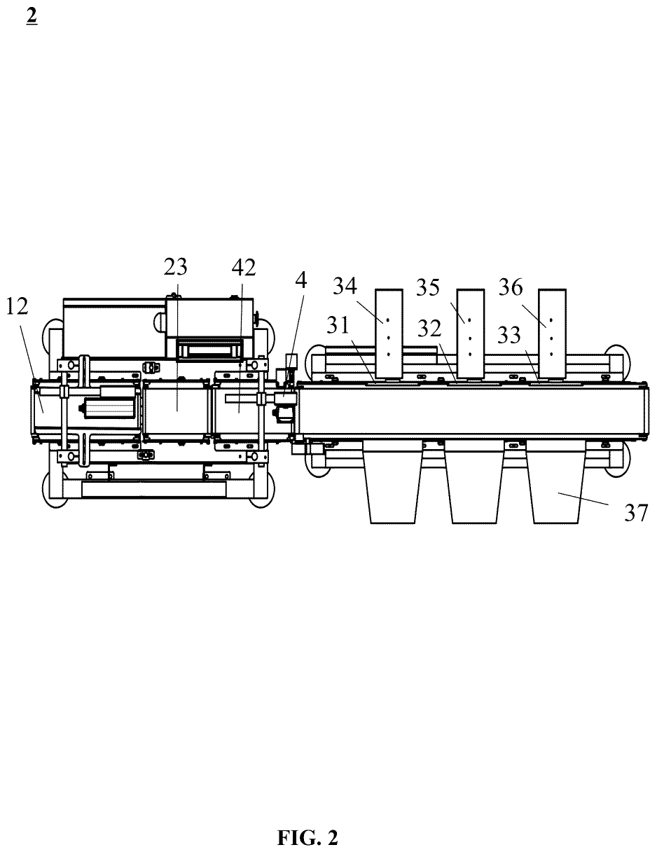

FIG. 1 is a schematic diagram illustrating an overall structure of a high-throughput and accurate phenotype measurement system for shellfish according to some embodiments of the present disclosure. FIG. 2 is a schematic diagram illustrating a top-view of a high-throughput and accurate phenotype measurement system for shellfish according to some embodiments of the present disclosure.

In some embodiments, as shown in FIG. 1 to FIG. 2, a high-throughput and accurate phenotype measurement system for shellfish comprises a body size measurement unit 1, a dynamic weighing unit 2, an automatic sorting unit 3, an information acquisition unit 4, and an intelligent control unit 5 arranged in sequence. The body size measurement unit 1 is configured to measure a body size of a shellfish individual, the dynamic weighing unit 2 is configured to measure a weight of the shellfish individual, the automatic sorting unit 3 is configured to sort and collect the shellfish individual based on an acquired trait measurement value, the information acquisition unit 4 is configured to capture and record sample information of a candidate parent, and the intelligent control unit 5 is configured to control the body size measurement unit 1, the dynamic weighing unit 2, the automatic sorting unit 3, and the information acquisition unit 4.

The body size measurement unit 1 may rapidly measure the body size of the shellfish individual with high precision. The shellfish individual includes at least one shell species, for example, at least one of chlamys farreri, mizuhopecten yessoensism, crassostrea gigas, ruditapes philippinarum, sinonovacula constricta, or the like. The body size may include dimensional parameters of the shellfish individual, for example, a shell length, a shell width, a shell height, a shell area, and a shell perimeter.

In some embodiments, the body size measurement unit 1 includes a laser rangefinder, a digital caliper, or the like.

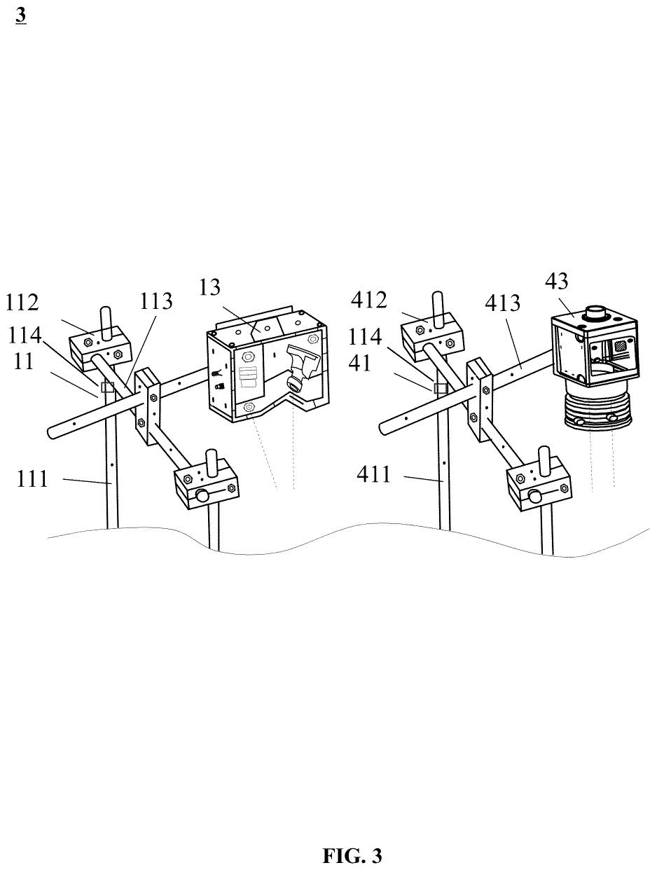

In some embodiments, the body size measurement unit 1 includes a first conveyor 12 and a three-dimensional laser scanner 13. More information about the first conveyor 12 and the three-dimensional laser scanner 13 may be referred to FIG. 3 and the related descriptions thereof.

The dynamic weighing unit 2 may rapidly measure the weight of the shellfish individual with high precision. In some embodiments, the dynamic weighing unit 2 includes a dynamic weighing sensor, a weighing conveyor belt, or the like.

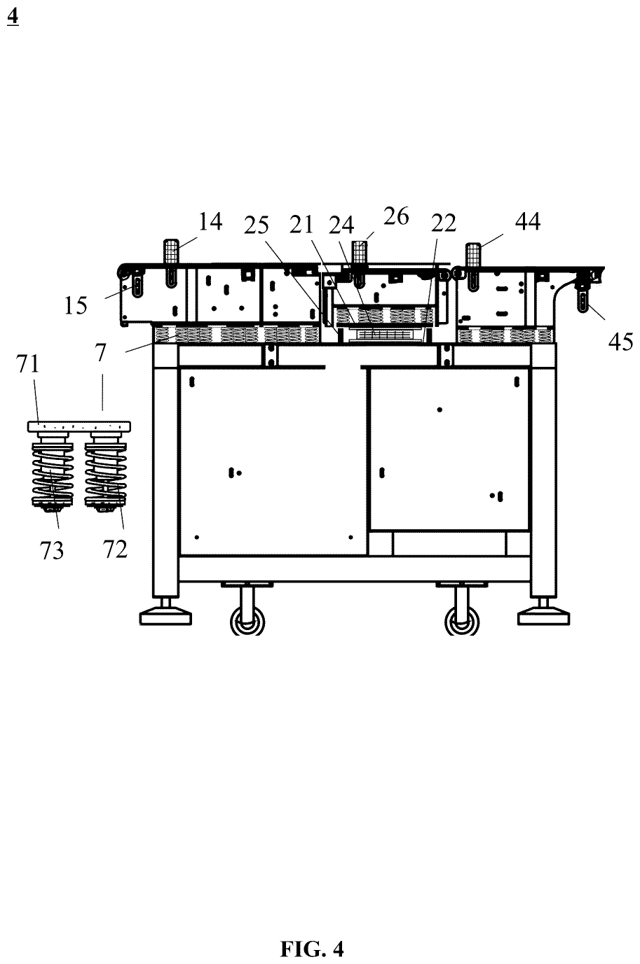

In some embodiments, the dynamic weighing unit 2 includes a second conveyor 23 and a pressure sensor 24, or the like. More information about the second conveyor 23 and the pressure sensor 24 may be referred to FIG. 4 and the related descriptions thereof.

The automatic sorting unit 3 may be configured as an automatic sorting device, such as a gravity separator, a vibrating screen, or a photoelectric sorter.

In some embodiments, the automatic sorting unit 3 includes a first pusher 31, a second pusher 32, and a third pusher 33 connected to a first air pump 34, a second air pump 35, and a third air pump 36, respectively. More information about the first pusher 31, the second pusher 32, the third pusher 33, the first air pump 34, the second air pump 35, and the third air pump 36 may be referred to FIG. 2 and the related descriptions thereof.

A trait measurement value includes the body size and the weight of the shellfish individual. In some embodiments, the automatic sorting unit 3 is configured to sort and collet the shellfish individual based on the trait measurement value in various manners. For example, the automatic sorting unit 3 may look up a predetermined sorting table to determine a sorting category of the shellfish individual based on the body size and/or the weight. The predetermined sorting table includes a mapping relationship between a body size and/or weight and a sorting category. The mapping relationship may be manually preset based on experiences. For example, different sorting species of shellfish individuals correspond to different ranges of body sizes and/or weights, or the like.

A candidate parent refers to a shellfish individual to be measured and sorted.

Sample information refers to detailed data and feature records of each candidate parent. For example, the species, weight, and body size of a sample shellfish individual.

The information acquisition unit 4 may be configured as an information acquisition device, such as a radio frequency identification system.

In some embodiments, the information acquisition unit 4 includes a third conveyor 42 and a barcode scanner 43. More information about the third conveyor 42 and the barcode scanner 43 may be referred to FIG. 3 and the related descriptions thereof.

In some embodiments, the intelligent control unit 5 includes a processor. The processor may include at least one of a central processing unit (CPU), a graphics processor (GPU), a field programmable gate array (FPGA), or the like.

In some embodiments, the intelligent control unit 5 may collect operational data of the high-throughput and accurate phenotype measurement system for shellfish, and integrate, store, and manage the operational data. For example, the operational data includes body size information of the body size measurement unit 1, weight information of the dynamic weighing unit 2, a sorting result of the automatic sorting unit 3, and sample information acquired by the information acquisition unit 4.

In some embodiments, as shown in FIG. 1, the body size measurement unit 1, the dynamic weighing unit 2, the automatic sorting unit 3, the information acquisition unit 4, and the intelligent control unit 5 are all fixed to a base support 6.

The base support 6 is used to support the structure of high-throughput and accurate phenotype measurement system for shellfish. In some embodiments, the base support 6 includes a plurality of legs, as shown in FIG. 1.

In some embodiments of the present disclosure, by fixing the body size measurement unit, the dynamic weighing unit, the automatic sorting unit, the information acquisition unit, and the intelligent control unit to the base support, the stability and safety of the structure can be effectively improved, and equipment vibration and displacement can be reduced. At the same time, the centralized fixation design optimizes space utilization, making maintenance and repair easier.

FIG. 3 is a schematic diagram illustrating a portion of structures of a body size measurement unit and an information acquisition unit according to some embodiments of the present disclosure.

In some embodiments, as shown in FIG. 3, the body size measurement unit 1 includes a first fixation device 11, the information acquisition unit 4 includes a second fixation device 41, and the first fixation device 11 and the second fixation device 41 are both configured with electronic control adjustment assemblies 114. The intelligent control unit 5 is configured to automatically adjust a height of the first fixation device 11 and a height of the second fixation device 41 using the electronic control adjustment assembly 114.

The first fixation device 11 is a device for fixing the body size measurement unit 1. In some embodiments, the first fixation device 11 includes a first vertical bar 111 and a first horizontal bar 113, as shown in FIG. 3. The first vertical bar 111 is mounted on the base support 6. The first vertical bar 111 is arranged along a height direction of the body size measurement unit 1. The first horizontal bar 113 is arranged along a horizontal direction of the body size measurement unit 1. The first horizontal bar 113 is located above the first conveyor 12.

In some embodiments, the first fixation device 11 includes at least two first vertical bars 111. For example, the two first vertical bars 111 are provided on two sides of the first conveyor 12, respectively, and do not contact a conveyor belt of the first conveyor 12.

In some embodiments, the first vertical bar 111 may include a plurality of connection bars. The plurality of connection bars have different diameters, and connection bars with smaller diameters may be socketed inside connection bars with larger diameters.

The second fixation device 41 is a device for fixing the information acquisition unit 4. In some embodiments, the second fixation device 41 includes a second vertical bar 411 and a second horizontal bar 413, as shown in FIG. 3. The second vertical bar 411 and the second horizontal bar 413 are provided in a similar manner and structure as the first vertical bar 111 and the first horizontal bar 113.

In some embodiments, the second fixation device 41 includes at least two second vertical bars 411. For example, the two second vertical bars 411 are provided on two sides of the third conveyor 42, respectively, and do not contact a conveyor belt of the third conveyor 42.

In some embodiments, the electronic control adjustment assembly may include a drive motor. The drive motor may pull a vertical bar with a small diameter by a predetermined distance from a vertical bar with a large diameter and lock the vertical bar with a small diameter in place to adjust the height. The predetermined distance may be set according to the demand, and the predetermined distance is smaller than the length of a bar structure.

In some embodiments of the present disclosure, adjusting the height of the first fixation device and the height of the second fixation device using the electronic control adjustment assembly can adjust a height of the body size measurement unit 1 and a height of the information acquisition unit 4. At the same time, errors in manual adjustment can be effectively avoided and the automation degree can be improved.

In some embodiments of the present disclosure, the high-throughput and accurate phenotype measurement system for shellfish can realize rapid and accurate measurement and sorting of shellfish through the cooperation of various units. The automated design of the system significantly improves efficiency, reduces manual intervention, and reduces the possibility of error. At the same time, the accurate measurement of body size and weight provides a reliable database for scientific research and breeding management. The information acquisition unit can capture and record sample information of a candidate parent, which enhances the traceability of the system. Besides, the intelligent control unit can optimize the collaboration between various units to improve overall performance and stability.

FIG. 4 is a schematic diagram illustrating the structures of a vibration-absorbing device and adjacent parts according to some embodiments of the present disclosure.

In some embodiments, as shown in FIG. 2 to FIG. 4, the body size measurement unit includes the first conveyor 12 and the three-dimensional laser scanner 13. One side of the first conveyor 12 is provided with a first through-beam photoelectric sensor 14 and a first encoder 15, the first through-beam photoelectric sensor 14 and the first encoder 15 are both connected to the three-dimensional laser scanner 13, and the three-dimensional laser scanner 13 is connected to the intelligent control unit 5 through a transmission control protocol (TCP).

The transmission control protocol is a network communication protocol used for new types of data transfer between units.

The first conveyor 12 is configured to transfer a shellfish individual to the body size measurement unit 1. In some embodiments, the first conveyor 12 includes a conveyor belt.

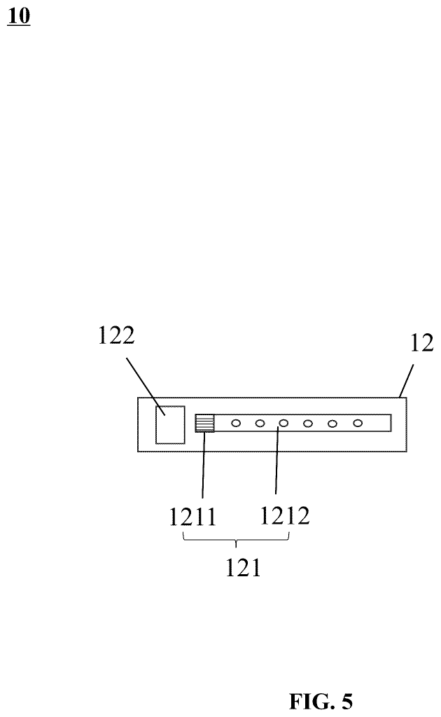

FIG. 5 is a schematic diagram illustrating an exemplary structure of a first conveyor according to some embodiments of the present disclosure.

In some embodiments, as shown in FIG. 5, the first conveyor 12 is configured with an automatic cleaning assembly 121. The automatic cleaning assembly 121 includes a cleaning brush 1211 and a cleaning water line 1212. The automatic cleaning assembly 121 is configured to clean a surface of a shellfish individual.

The cleaning brush 1211 is configured to scrub the surface of the shellfish individual. In some embodiments, the cleaning brush 1211 includes bristles and a driving device.

The cleaning water line 1212 is a piping system used to transport a cleaning liquid, usually water. In some embodiments, the cleaning water line 1212 includes a water hose and a spray nozzle.

In some embodiments, the intelligent control unit 5 may control the automatic cleaning assembly 121 to scrub the surface of the shellfish individual using the cleaning brush 1211, and control the automatic cleaning assembly 121 to rinse the surface of the shellfish individual through the cleaning water line 1212.

In some embodiments of the present disclosure, the water plants attached to the surface of the shellfish individual are cleaned using an automatic cleaning assembly, which makes it easier for an information acquisition unit to identify an identification label affixed to the surface of the shellfish individual, thereby improving the identification efficiency.

In some embodiments, as shown in FIG. 5, the first conveyor 12 is configured with a position correction assembly 122. The position correction assembly 122 is connected to a conveyor belt of the first conveyor 12, and the position correction assembly 122 includes an oscillation device, the oscillation device being configured to control the stabilization of the center of gravity of the shellfish individual on the conveyor belt through oscillation.

The position correction assembly is an assembly configured to correct a position of the shellfish individual on the conveyor belt. In some embodiments, the position correction assembly is mechanically connected to the conveyor belt. For example, the position correction assembly is fixed to the conveyor belt by a nut. As another example, the position correction assembly may be fixed to the conveyor belt by a locating pin.

In some embodiments, the oscillation device may include a drive motor.

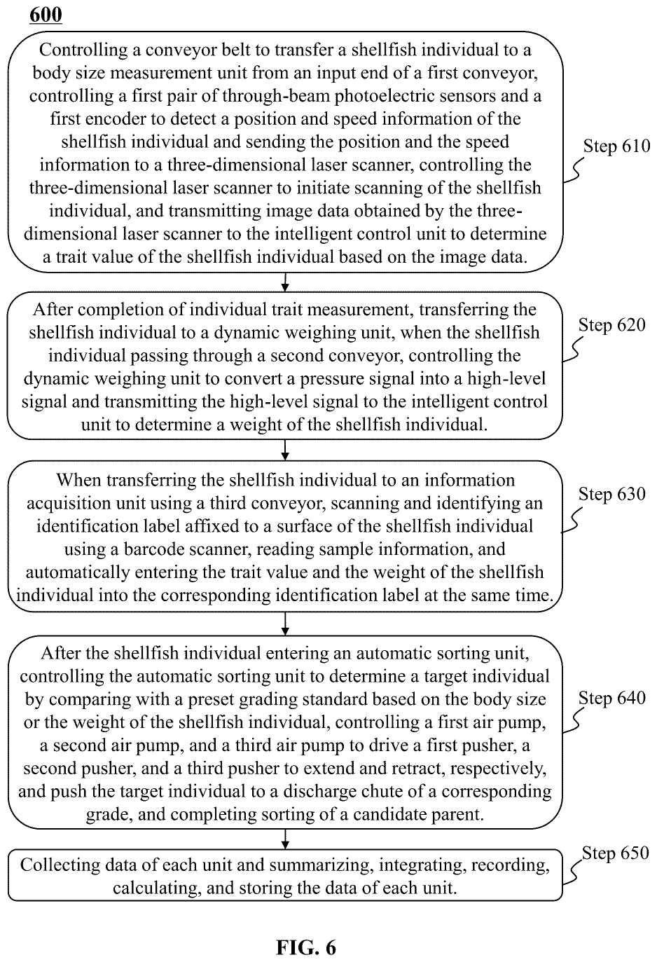

In some embodiments, the intelligent control unit 5 may control an oscillation time and an oscillation amplitude of the oscillation device by adjusting the output power of the drive motor according to the species of the shellfish individual. More information about the species of the shellfish individual can be referred to FIG. 6 and the related descriptions thereof.

The oscillation time and the oscillation amplitude may be obtained by querying a shellfish information table. The shellfish information table includes the species of different shellfish individuals and corresponding oscillation times and oscillation amplitudes. In some embodiments, the shellfish information table may be constructed based on historical oscillation data. For example, based on the species of a shellfish individual in the historical oscillation data, when an average of measurement differences of shellfish individuals of the species is less than a preset difference threshold, the corresponding minimum oscillation time and the corresponding minimum oscillation amplitude can be designated as a corresponding oscillation time and a corresponding oscillation amplitude for the shellfish individual of the species. The measurement difference is a difference between a body size of a shellfish individual measured using the body size measurement unit and a body size of the shellfish individual measured manually. The preset difference threshold may be set empirically, for example, the preset difference threshold is 5%.

Controlling the center of gravity of the shellfish individual on the conveyor belt using the oscillation device can effectively improve the accuracy of shellfish information acquisition and increase the automation degree of the high-throughput and accurate phenotype measurement system for shellfish.

The first through-beam photoelectric sensor 14 is configured to detect the presence and position of the shellfish individual on the first conveyor 12. The first through-beam photoelectric sensor may be a photodetector.

The first encoder 15 is configured to detect the position and speed of the shellfish individual on the first conveyor 12.

The three-dimensional laser scanner is configured to acquire image data of the shellfish individual. The image data includes a 3D point cloud map, a colored point cloud depth map, and a black-and-white depth map, or the like.

In some embodiments, the three-dimensional laser scanner 13 is located above the first conveyor 12, and a scanning direction of the three-dimensional laser scanner 13 is aligned with the conveyor belt of the first conveyor, as shown in FIG. 3.

The scanning direction is a direction in which the three-dimensional laser scanner 13 emits laser beams and receives a reflected signal.

In some embodiments, the three-dimensional laser scanner 13 is located directly above the first conveyor 12, and the scanning direction of the three-dimensional laser scanner 13 is vertically downward, directly faces the conveyor belt of the first conveyor 12.

In some embodiments, the three-dimensional laser scanner 13 is provided on the first fixation device 11 above the first conveyor 12, as shown in FIG. 3. More information about the first fixation device 11 can be referred to FIG. 3 and the related descriptions thereof.

In some embodiments, the first fixation device 11 includes a first position adjuster 112. The first position adjuster 112 is disposed in a middle-upper portion of the first vertical bar 111. The first position adjuster 112 is mounted with the first horizontal bar 113, and the first horizontal bar 113 is configured with the three-dimensional laser scanner 13.

In some embodiments, a height of the three-dimensional laser scanner 13 can be adjusted using the first horizontal bar 113. A measurement range and resolution of the three-dimensional laser scanner 13 can be set as desired.

Setting the three-dimensional laser scanner 13 on the first conveyor 12 ensures that the scanning direction of the three-dimensional laser scanner 13 is aligned with the conveyor belt of the first conveyor 12, which improves the accuracy of data acquisition of the three-dimensional laser scanner 13.

The body size measurement unit enables accurate measurement of the body size of the shellfish individual through the cooperation between the three-dimensional laser scanner, the first through-beam photoelectric sensor, and the first encoder.

In some embodiments, as shown in FIG. 2 and FIG. 4, the dynamic weighing unit 2 includes the second conveyor 23 and the pressure sensor 24. One side of the second conveyor 23 is provided with a second through-beam photoelectric sensor that are connected to the pressure sensor 24, and the pressure sensor 24 is connected to the intelligent control unit 5 through the transmission control protocol.

The structure of the second conveyor 23 is configured to transfer the shellfish individual from the body size measurement unit to the dynamic weighing unit.

The pressure sensor is configured to measure the weight of the shellfish individual on the second conveyor. In some embodiments, the pressure sensor is located below the second conveyor.

In some embodiments, the dynamic weighing unit 2 includes an upper support frame 21 and a lower support frame 22, as shown in FIG. 2 and FIG. 4. The upper support frame 21 is mounted below the second conveyor 23, and the lower support frame 22 is fixed to the base support 6. The pressure sensor 24 is mounted between the upper support frame 21 and the lower support frame 22. The accuracy of the pressure sensor 24 can be set according to the demand, for example, the accuracy is 0.01 g. A protective plate 25 is provided around the pressure sensor 24, and the protective plate 25 is mounted on the base support 6.

The second through-beam photoelectric sensor is configured to detect the presence and position of the shellfish individual on the second conveyor 23.

The dynamic weighing unit realizes accurate measurement of the weight of the shellfish individual using the second conveyor and the pressure sensor.

In some embodiments, the automatic sorting unit 3 includes a plurality of pushers and a plurality of discharge chutes, thereby enabling the separation of different shellfish.

In some embodiments, as shown in FIG. 2, the automatic sorting unit 3 includes the first pusher 31, the second pusher 32, and the third pusher 33 connected to the first air pump 34, the second air pump 35, and the third air pump 36, respectively. The first air pump 34, the second air pump 35, and the third air pump 36 are mounted on the base support 6 and connected to the intelligent control unit 5 through the transmission control protocol, and the intelligent control unit 5 is configured to control the first pusher 31, the second pusher 32, and the third pusher 33 to push a shellfish individual that is graded into the discharge chute 37.

The first air pump 34 is used to provide power to the first pusher 31. The second air pump 35 is used to provide power to the second pusher 32. The third air pump 36 is used to provide power to the third pusher 33.

In some embodiments of the present disclosure, efficient grading and automatic pushing of the shellfish can be realized through the cooperation among the automatic sorting unit, the pusher, the air pump, and the discharge chute.

In some embodiments, as shown in FIG. 2 to FIG. 4, the information acquisition unit 4 includes the third conveyor 42 and the barcode scanner 43. One side of the third conveyor 42 is provided with a third through-beam photoelectric sensor 44 and a third encoder 45, the third through-beam photoelectric sensor 44 and the third encoder 45 are both connected to the barcode scanner 43, and the barcode scanner 43 is connected to the intelligent control unit 5 through the transmission control protocol.

The third conveyor 42 is configured to transfer the shellfish individual from the automatic sorting unit to the information acquisition unit.

The third through-beam photoelectric sensor 44 is configured to detect the presence and position of the shellfish individual on the third conveyor 42. The third encoder 45 is configured to detect the position and speed of the shellfish individual on the third conveyor 42.

The barcode scanner is configured to read an identification label affixed to the surface of the shellfish individual. The identification label includes at least one of a barcode, a QR code, or other identifiable labels, etc.

In some embodiments of the present disclosure, the information acquisition unit utilizes the third conveyor and the barcode scanner to achieve efficient collection and management of shellfish information.

In some embodiments, the barcode scanner 43 is located above the third conveyor 42, with a scanning direction of the barcode scanner 43 oriented toward the third conveyor 42, as shown in FIG. 2 to FIG. 3.

In some embodiments, the barcode scanner 43 is provided on the second fixation device 41 above the third conveyor 42. More information about the second fixation device 41 can be referred to FIG. 3 and the related descriptions thereof.

In some embodiments, the second fixation device 41 includes a second position adjuster 412. The second position adjuster 412 is provided in a middle-upper portion of the second vertical bar 411. The second position adjuster 412 is mounted with the second horizontal bar 413, and the second horizontal bar 413 is configured with the barcode scanner 43. For example, the barcode scanner 43 is located directly above the third conveyor 42 as shown in FIG. 3.

In some embodiments, a height of the barcode scanner 43 can be adjusted using the second horizontal bar 413. The scanning speed and the identification accuracy of the barcode scanner 43 can be set according to specific needs. For example, the barcode scanner 43 has a scanning speed of 50 times per second and an identification accuracy of 99.9%.

In some embodiments, the identification label is affixed to the surface of the shellfish individual. Information of the shellfish individual is recorded on the identification label, and the information acquisition unit 4 is further configured to: automatically enter a body size and a weight of the shellfish individual obtained using the body size measurement unit 1 and the dynamic weighing unit 2 into the corresponding identification label and associatively bind the identification label to information of the shellfish individual; and automatically reads historical data and records new measurement data to continuously track, measure, and record a growth trait of the shellfish individual.

In some embodiments, the information acquisition unit 4 may scan an identification label with a side length greater than a preset side length threshold. For example, the preset side length threshold is 8 millimeters, thereby increasing the scanning accuracy of the information acquisition unit 4. In some embodiments, the identification label is affixed to the surface of the shellfish individual. The identification label may be made of PVC, and the identification label may be pasted on the surface of the shellfish individual using waterproof materials (e.g., seawater-resistant rapid-setting gel), to ensure that two-dimensional codes or bar codes on the identification label are not corroded by seawater.

The information of the shellfish individual includes a shellfish code, etc.

In some embodiments, the high-throughput and accurate phenotype measurement system for shellfish can perform periodic measurements on the shellfish individual, thereby continuously updating data of the shellfish individual and monitoring the trait of the shellfish individual. The periodicity of measurements may be set based on demand or experience.

Recording the information of the shellfish individual through the identification label can facilitate the efficient management and tracking of information of the shellfish individual. Recording the measurement information into corresponding identification labels and updating the information related to shellfish can ensure the accuracy and completeness of the information. At the same time, it reduces the errors and workload of manual operation, thereby improving the efficiency of data processing.

In some embodiments, as shown in FIG. 4, a vibration-absorbing device is mounted below the first conveyor 12, the second conveyor 23, and the third conveyor 42, and the vibration-absorbing device includes a rubber gasket 71, a spring 72, and a buffer 73.

The rubber gasket 71 absorbs and isolates low-frequency oscillations generated by a conveyor during transportation. In some embodiments, the rubber gasket 71 is mounted between the conveyor and the base support.

In some embodiments, the spring 72 is adjustable based on the load of the conveyor. For example, a count of springs may be increased or springs with higher stiffness may be used on a conveyor with a higher load.

The buffer 73 ensures that the conveyor remains smooth during operation by absorbing high-frequency oscillations and shocks.

Setting the vibration-absorbing device 7 is designed to filter vibrations during the operation of the conveyor, improving the smoothness of transfer, reducing the impact of shellfish individual swaying on measurements, and enhancing the accuracy of phenotype data collection.

FIG. 6 is a flowchart illustrating a process of a high-throughput and accurate phenotype measurement method for shellfish according to some embodiments of the present disclosure.

In some embodiments, an exemplary process of the high-throughput and accurate phenotype measurement method for shellfish is shown in a process 600, as shown in FIG. 6. The process 600 includes step 610 to step 650. Step 610 to step 650 may be executed by the intelligent control unit 5 of a high-throughput and accurate phenotype measurement system for shellfish.

In step 610, a conveyor belt is controlled to transfer a shellfish individual to a body size measurement unit from an input end of a first conveyor, a first through-beam photoelectric sensor and a first encoder are controlled to detect a position and speed information of the shellfish individual and send the position and the speed information to a three-dimensional laser scanner, the three-dimensional laser scanner is controlled to initiate scanning of the shellfish individual, and image data obtained by the three-dimensional laser scanner is transmitted to the intelligent control unit to determine a trait value of the shellfish individual based on the image data.

In some embodiments, the intelligent control unit 5 may activate the first conveyor 12, the second conveyor 23, and the third conveyor 42 to regulate the operation speed of a conveyor belt of each conveyor to a target value. The target value may be set based on demand or experience. Target values corresponding to the first conveyor, the second conveyor, and the third conveyor may be the same or different.

In some embodiments, the first through-beam photoelectric sensor 14 may detect a position of the shellfish individual on the conveyor belt using a through-beam photoelectric sensor. The first encoder 15 may obtain the speed information of the shellfish individual on the conveyor belt by measuring the rotational motion of the conveyor belt through a rotary encoder.

The image data includes a colored point cloud depth map and a black-and-white depth map of the shellfish individual. In some embodiments, the intelligent control unit 5 may preprocess the image data to determine the trait value of the shellfish individual.

Preprocessing includes removing shadows and backgrounds, converting image size to actual size based on the number of pixel points, or the like. The trait value of the shellfish individual includes the shell height, shell length, shell width, shell cross-sectional area, and shell cross-section perimeter of the shellfish individual, etc. For example, the intelligent control unit 5 may calculate the shell width of the shellfish individual based on a perpendicular distance between the highest point and a reference plane in the image data through a predetermined height scale factor. The reference plane may be the plane where the conveyor belt of the first conveyor 12 is located.

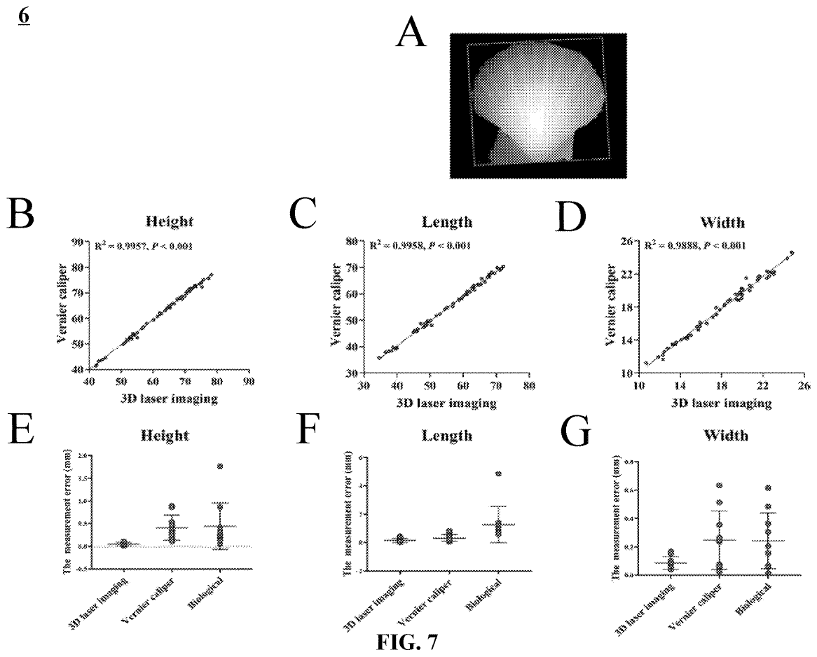

FIG. 7 is a schematic diagram illustrating data measurement and analysis of a body size measurement unit according to some embodiments of the present disclosure. Image A represents a black-and-white depth map of a chlamys farreri scanned using a body size measurement unit. Image B to image D are schematic diagrams illustrating regression analysis of shell height, shell length, and shell width obtained using a body size measurement unit and a vernier caliper. Image E to image G are schematic diagrams illustrating measurement errors of a single sample measured multiple times under different measurement methods for shell height, shell length, and shell width. In image B to image D, the horizontal coordinates represent a shell height, shell length, and shell width obtained using the body size measurement unit, respectively, and the vertical coordinates represent a shell height, shell length, and shell width obtained using the vernier caliper, respectively. In image E to image G, the horizontal coordinates represent different measurement manners (including measurement using the body size measurement unit, measurement using the vernier caliper, and measurement through a biological manner), and the vertical coordinates represent the measurement error of shell height, the measurement error of the shell length, and the measurement error of the shell width of corresponding measurement manners, respectively.

In some embodiments, 50 to 60 shellfish individuals were randomly selected. Species of the shellfish individuals include chlamys farreri, mizuhopecten yessoensism, crassostrea gigas, ruditapes philippinarum, and sinonovacula constricta. Body sizes of all of the shellfish individuals were measured using a high-throughput and accurate phenotype measurement system for shellfish (hereinafter referred to as a phenotype measurement system) and a vernier caliper, respectively, and data obtained therefrom were analyzed and recorded.

For example, as shown in FIG. 7, take the chlamys farreri as an example, image A of FIG. 7 represents a black-and-white depth map of a chlamys farreri. For example, as shown in image B to image D of FIG. 7, the regression analysis shows that the determination coefficient R² of the phenotype measurement system and the vernier caliper for the measurement of the shell height, the shell length, and the shell width are 0.9957, 0.9958, and 0.9888, respectively, with a significance level P being less than 0.001, indicating that there is a high correlation between results of the phenotype measurement system and the vernier caliper.

Using the body size measurement unit 1 and the vernier caliper, 10 manual measurements were performed on a single sample of chlamys farreri, e.g., each of the 10 individuals measuring the single sample once. As shown in image E to image G of FIG. 7, the repetition accuracy analysis shows that the residual error ranges of measurement results of the phenotype measurement system, the vernier caliper, and the manual measurement on shell height were in a range of 0.01 mm to 0.11 mm, in a range of 0.11 mm to 0.89 mm, and in a range of 0.05 mm to 1.76 mm respectively, and the body size measurement unit 1 has the smallest error, demonstrating higher measurement accuracy. Similarly, the experimental results of the measurements on the mizuhopecten yessoensism, crassostrea gigas, ruditapes philippinarum, and sinonovacula constricta show that the body size measurement unit 1 of the high-throughput and accurate phenotype measurement method for shellfish also exhibits higher measurement accuracy and objectivity.

In step 620, after completion of individual trait measurement, the shellfish individual is transferred to a dynamic weighing unit, when the shellfish individual passing through a second conveyor, the dynamic weighing unit is controlled to convert a pressure signal into a high-level signal and the high-level signal is transmitted to the intelligent control unit to determine a weight of the shellfish individual.

The dynamic weighing unit 2 may obtain a pressure signal using the pressure sensor 24. When the second conveyor 23 is in an unloaded state, the pressure sensor 24 is zeroed; when the shellfish individual is conveyed in the second conveyor 23, the voltage of the pressure sensor changes, and a changed pressure signal is output. The pressure signal is amplified by an amplification circuit into the high-level signal, and the high-level signal is transmitted to the intelligent control unit 5, the intelligent control unit 5 converts the pressure signal into a digital signal that is easy to process, thereby realizing the dynamic and rapid measurement of the weight of the shellfish individual.

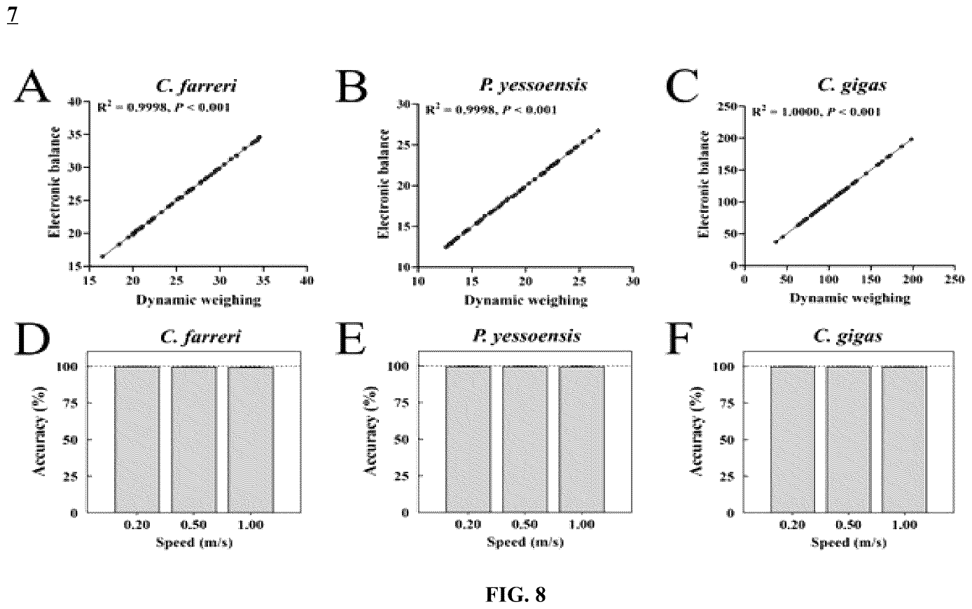

FIG. 8 is a schematic diagram illustrating data measurement and analysis of a dynamic weighing unit according to some embodiments of the present disclosure, wherein image A to image C are schematic diagrams illustrating regression analysis of body weights obtained using a dynamic weighing unit and an electronic balance, and image D to image F are schematic diagrams illustrating the accuracy of weight measurement of chlamys farreri, mizuhopecten yessoensism, and crassostrea gigas at different transfer speeds. In image A to image C of FIG. 8, the horizontal coordinates denote weights of the chlamys farreri, mizuhopecten yessoensism, and crassostrea gigas obtained using a dynamic weighing unit, respectively, and the vertical coordinates denote weights of the chlamys farreri, mizuhopecten yessoensism, and crassostrea gigas obtained using an electronic balance, respectively. In image D to image F of FIG. 8, the horizontal coordinates denote the transfer speed of a conveyor belt, and the vertical coordinates indicate the accuracy of the weight measurement of the chlamys farreri, mizuhopecten yessoensism, and crassostrea gigas, respectively.

In some embodiments, 50 to 60 shellfish individuals were randomly selected as samples. Weights of the shellfish individuals were measured using a phenotype measurement system and an electronic balance, respectively, and data obtained were analyzed and recorded. As shown in image A of FIG. 8, the regression analysis shows that the determination coefficient R² between the phenotype measurement system and the electronic balance for the measurement of the weight of chlamys farreri was 0.9998, with a significance level P being less than 0.001, indicating that there is a high correlation between the phenotype measurement system and the vernier caliper. Similarly, as shown in image B and image C of FIG. 8, weight data obtained using the phenotype measurement system and the vernier caliper were also highly correlated on other shellfish, and the determination coefficient was 0.9998, with a significant level P less being than 0.001, indicating that there is a high correlation between the phenotype measurement system and the vernier caliper. As shown in image D of FIG. 8, the accuracy of the phenotype measurement system in weight measurement of chlamys farreri was tested at different transfer speeds, and results show that the measurement accuracy was 99.79%, 99.65%, and 99.51% at 0.2 m/s, 0.5 m/s and 1.0 m/s transfer speeds, respectively. As shown in image E and image F of FIG. 8, the measurement accuracy of total wet weight exceeds 99.50% at different transfer speeds on other shellfish.

In step 630, when transferring the shellfish individual to an information acquisition unit using a third conveyor, an identification label affixed to a surface of the shellfish individual is scanned and identified using a barcode scanner, sample information is read, and the trait value and the weight of the shellfish individual are automatically entered into the corresponding identification label at the same time.

The trait value of the shellfish individual includes parameter values of a body size of the shellfish individual measured using the body size measurement unit.

In some embodiments, when the shellfish individual is transferred to the information acquisition unit 4, light from the barcode scanner 43 illuminates the identification label affixed to the surface of the shellfish individual, and the reflected light passes through a photoelectric converter to generate an electrical signal. The electrical signal is amplified by an amplification circuit into a high-level signal and transmitted to the intelligent control unit 5. The intelligent control unit 5 converts the high-level signal into a digital signal to achieve data collection from the identification label that contains information affixed to the surface of the shellfish individual.

In some embodiments, the intelligent control unit 5 records the body size and the weight measured using the body size measurement unit 1 and the dynamic weighing unit 2 into an identification label and associatively binds the identification label to information of the shellfish individual.

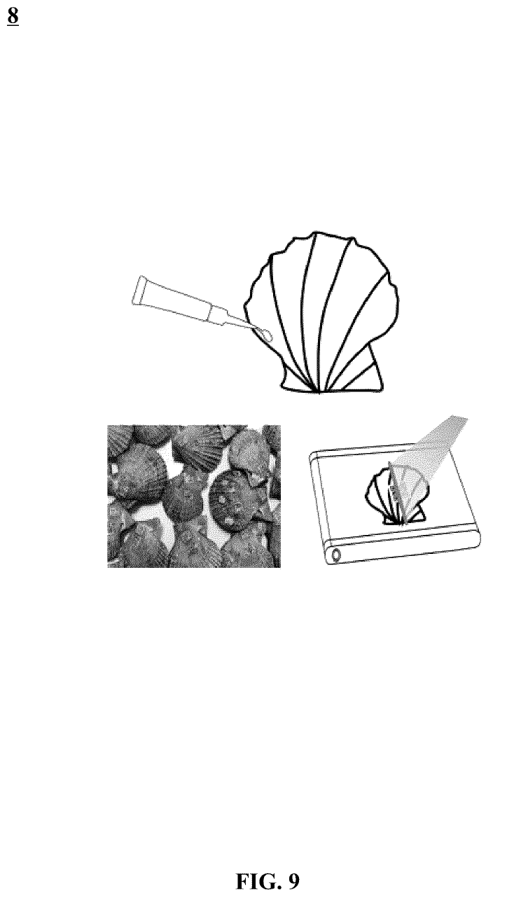

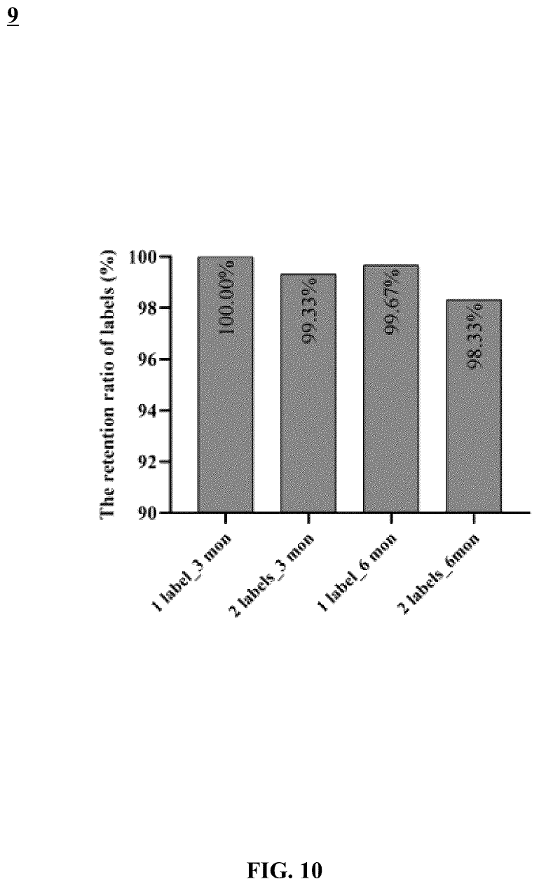

FIG. 9 is a schematic diagram illustrating individual labeling and sample information acquisition based on barcode technology according to some embodiments of the present disclosure. FIG. 10 is a schematic diagram illustrating a retention ratio of scallop labels from which label information can be normally collected after 3 or 6 months of offshore farming according to some embodiments of the present disclosure.

In some embodiments, the intelligent control unit 5 may batch generate a QR code containing labeling information of a shellfish individual via Excel. For example, as shown in FIG. 9, take a chlamys farreri as an example, a label with a QR code is affixed to the surface of the chlamys farreri using seawater-resistant rapid-setting gel, and individual information of the chlamys farreri is automatically captured and recorded using a high-resolution barcode scanner. To verify the durability of the label and the readability of the information, the labeled chlamys farreri was reintroduced to the sea culture.

As shown in FIG. 10, the horizontal coordinates denote the different combinations of culture time and a count of labels, and the vertical coordinates denote the retention ratio of labels. The number of labels on all chlamys farreri individuals is regularly counted. After 3 months, all individuals carry at least one label, and 99.33% of individuals carry two labels. After 6 months, 99.67% of individuals still retain at least one label, and 98.33% of individuals retain two labels. During the measurement period, the QR code on the labels remains clear and visible, and can be quickly and accurately read by a high-resolution barcode scanner. The intelligent control unit can enter a body size and weight of a chlamys farreri obtained using the body size measurement unit 2 and the dynamic weighing unit 3 directly into a corresponding identification label and associatively bind the identification label to information of the chlamys farreri. After the measurement, the individuals are returned to the sea and regularly re-measured. Historical data is automatically retrieved and new data is recorded, enabling long-term continuous monitoring of the growth traits of shellfish individuals, which is of significant importance for growth rate analysis, understanding growth genetic mechanisms, and selecting individuals with superior growth traits.

In step 640, after the shellfish individual entering an automatic sorting unit, the automatic sorting unit is controlled to determine a target individual by comparing with a preset grading standard based on the body size or the weight of the shellfish individual, a first air pump, a second air pump, and a third air pump are controlled to drive a first pusher, a second pusher, and a third pusher to extend and retract, respectively, and push the target individual to a discharge chute of a corresponding grade, and sorting of a candidate parent is completed.

The target individual is a shellfish that satisfies a preset grading standard. The preset grading standard may be set empirically.

In some embodiments, the preset grading standard may be determined based on needs or experience.

In some embodiments, the preset grading standard may be determined based on at least one of the body size or the weight.

For example, taking a chlamys farreri as an example, a shell height grading standard includes: a shell height greater than or equal to 60 mm as grade 1, a shell height greater than 40 mm and less than 60 mm as grade 2, and a shell height less than or equal to 40 mm as grade 3. A shell weight grading standard includes: a shell weight greater than or equal to 40 g as grade 1, a shell weight greater than 20 g and less than 40 g as grade 2, and a shell weight less than or equal to 20 g as grade 3.

In step 650, data of each unit is collected and the data of each unit is summarized, integrated, recorded, calculated, and stored.

Data of each unit includes individual information, body size, weight, etc., of the shellfish individual.

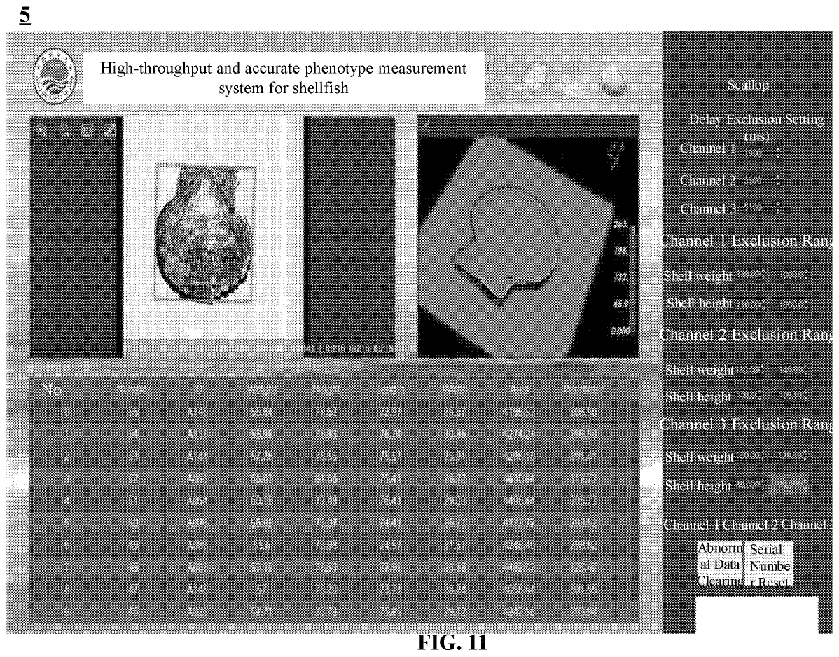

FIG. 11 is a schematic diagram illustrating a display page of an intelligent control unit according to some embodiments of the present disclosure.

In some embodiments, as shown in FIG. 11, the intelligent control unit 5 may automatically summarize, integrate, and record data of each unit, and present integrated data on a display screen in real-time. At the same time, the data of each unit is written in an Excel sheet, stored on a local hard disk, or exported via a USB interface for subsequent analysis.

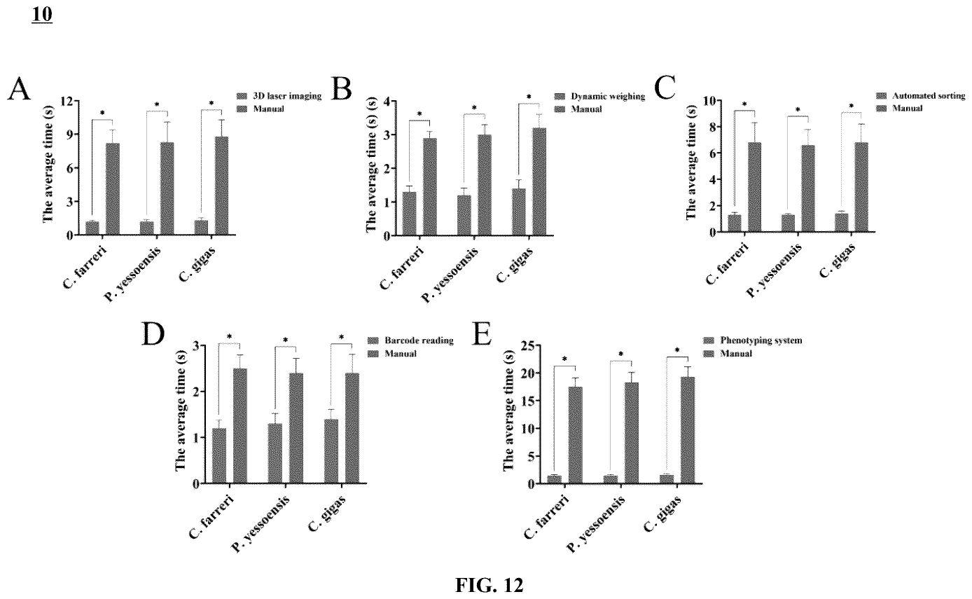

FIG. 12 is a schematic diagram illustrating a comparison of the work efficiency between a phenotype measurement system for shellfish and a manual measurement method according to some embodiments of the present disclosure, wherein image A to image E respectively represent a comparison of time consumption among a body size measurement unit, a dynamic weighing unit, an automatic sorting unit, an information acquisition unit, and an intelligent control unit and the manual measurement method. In image A to image E of FIG. 12, the horizontal coordinates denote different species of shellfish (including chlamys farreri, mizuhopecten yessoensism, and crassostrea gigas), and the vertical coordinates indicate the average time consumption of the measurements.

In some embodiments, the high-throughput phenotype measurement system and units thereof are utilized to measure a chlamys farreri, a mizuhopecten yessoensism, and a crassostrea gigas in sequence, and the time consumption of each unit is recorded. At the same time, the chlamys farreri, the mizuhopecten yessoensism, and the crassostrea gigas were measured using a manual measurement manner, and the time consumption of each step is recorded. As shown in image A of FIG. 12, take the chlamys farreri as an example, the time consumption of the body size measurement unit 1 is only one-seventh of the time consumption of the manual measurement manner. Similarly, as shown in image B to image D of FIG. 12, the time consumption of the dynamic weighing unit 2, the automatic sorting unit 3, and the information acquisition unit 4 is also much lower than the time consumed consumption of the manual measurement manner. In addition, as shown in image E of FIG. 12, the average time consumption for completing all the measurements using the phenotype measurement system is 1.6±0.2 seconds, whereas the average time consumption for completing all the measurements using the manual measurement manner is 18.2=1.5 seconds, and the measurement speed of the phenotype measurement system is approximately 11 times faster than the measurement speed of the manual measurement manner. The phenotype measurement system is capable of measuring, sorting, and identifying thousands of individuals per hour, which is sufficient to meet high-throughput requirements.

In some embodiments of the present disclosure, the high-throughput and accurate phenotype measurement method for shellfish realizes a rapid and high-precision measurement of shellfish phenotypes, avoids subjective errors in manual measurements, and provides more accurate phenotypic data for genotyping and selection. At the same time, the automatic and high-precision sorting of candidate individuals and reading sample information based on the phenotype measurement data reduces the errors of manual selection of candidate parents and improves the selection accuracy. In addition, this method significantly reduces the manual effort and time costs in the parent selection process, greatly improving breeding efficiency and showing strong potential for industrial application.

In some embodiments, the intelligent control unit 5 is further configured to: based on image data, process the image data to output a species of a shellfish individual using a species analysis layer of a shellfish identification model, the shellfish identification model being a machine learning model; and automatically adjust a height and a rotation angle of a first fixation device and a height and a rotation angle of a second fixation device based on the species of the shellfish individual.

The shellfish identification model is a model used to identify a species and a trait value of a shellfish individual.

The species analysis layer is a model used to determine the species of the shellfish individual. The species analysis layer is a machine learning model, e.g., a convolutional neural networks (CNN) model.

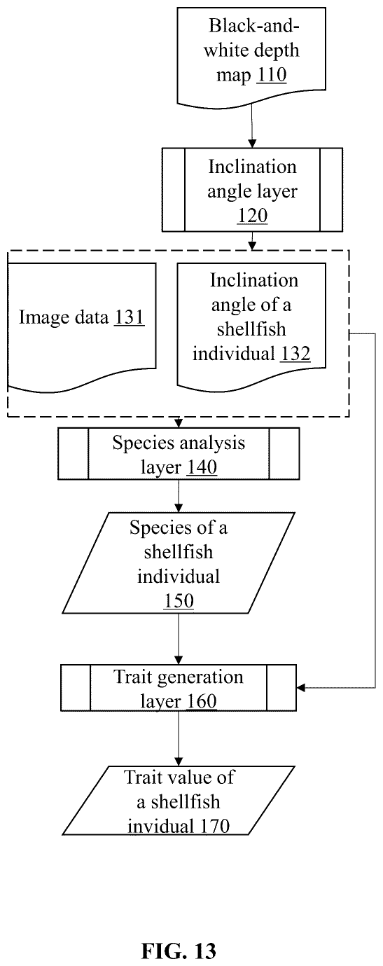

FIG. 13 is a schematic diagram illustrating an exemplary shellfish identification model according to some embodiments of the present disclosure.

In some embodiments, as shown in FIG. 13, an input to a species analysis layer 140 includes image data 131, and an output of the species analysis layer 140 includes a species of a shellfish individual 150.

The image data 131 includes a colored point cloud depth map and a black-and-white depth map. The processing of the image data by the species analysis layer includes removing shadows and background, etc. The species of the shellfish individual includes chlamys farreri, mizuhopecten yessoensism, crassostrea gigas, ruditapes philippinarum, sinonovacula constricta, or the like.

In some embodiments, the species analysis layer may be obtained by supervised learning training based on a large number of first training samples and first labels corresponding to the first training samples. In some embodiments, a plurality of first training samples with first labels may be input into an initial species analysis layer, a loss function is constructed based on the first labels and a result of the initial species analysis layer, and based on the loss function, parameters of the initial species analysis layer are iteratively updated using gradient descent or other manners. A model training is completed when a preset condition is met, and a trained species analysis layer is obtained. The preset condition may be that the loss function converges, the number of iterations reaches a threshold, and so on.

Each set of training samples in the first training samples may include sample image data. The sample image data includes a sample colored point cloud depth map and a sample black-and-white depth map. The first training sample may be obtained from historical scanning data of a three-dimensional laser scanner. The first label corresponding to the first training sample is a species of a sample shellfish individual corresponding to each set of training samples. The first label may be determined by manual labeling.

In some embodiments, the intelligent control unit 5 may determine the identification accuracy of the species analysis layer based on a difference between a body size of a shellfish individual output by a body size measurement unit and a historical measurement result of a shellfish of a same species; and if the difference is greater than a preset difference threshold, it is determined that the identification accuracy of the species analysis layer is low, and the species of the shellfish individual output by the species analysis layer may be incorrect, then manual verification is performed.

The preset difference threshold is related to the species of the shellfish individual, and the preset difference threshold may be determined by querying a shellfish information table.

More information about the shellfish information table can be found in FIG. 5 and the related descriptions thereof.

In some embodiments, the input to the species analysis layer 140 further includes an inclination angle of a shellfish individual 132, as shown in FIG. 13.

The inclination angle of the shellfish individual 132 is an angle between the shellfish individual and a horizontal plane.

In some embodiments, each set of training samples in the first training samples further includes an inclination angle of a sample shellfish individual.

Taking the inclination angle of the shellfish individual as the input of the species analysis layer considers the influence of a placement angle of the shellfish individual on a final identified species of the shellfish individual, it can make an output result of the species analysis layer more accurate, thereby expanding the application scenarios of the shellfish identification model.

Through the species analysis layer of the shellfish identification model, the species of shellfish individual can be easily and quickly identified, which facilitates the improvement of the accuracy of the subsequent information collection.

In some embodiments, the intelligent control unit 5 is further configured to generate the trait value of the shellfish individual based on the species of the shellfish individual, the image data, and the inclination angle of the shellfish individual using a trait generation layer of the shellfish identification model.

The trait generation layer is a model used to determine the trait value of the shellfish individual. In some embodiments, the trait generation layer is at least one of a machine learning model, e.g., a CNN model, a deep neural networks (DNN) model, or the like.

More information about the trait value of the shellfish individual can be found in FIG. 6 and the related descriptions thereof.

In some embodiments, as shown in FIG. 13, inputs to the trait generation layer 160 include the species of the shellfish individual 150, the image data 131, and the inclination angle of the shellfish individual 132, and an output of the trait generation layer 160 includes a trait value 170 of a shellfish individual.

In some embodiments, the trait generation layer may be obtained by training based on a large number of second training samples and second labels corresponding to the second training samples by a training methodology similar to that used for the species analysis layer.

Each set of training samples in the second training samples may include a species of a sample shellfish individual, sample image data, and an inclination angle of a sample shellfish individual. The sample image data may be obtained from historical scanning data of the three-dimensional laser scanner. The species of the sample shellfish individual may be obtained from historical output data from the species analysis layer. The inclination angle of the sample shellfish individual may be a different inclination angle of a shellfish individual placed manually. The second label corresponding to the second training sample is a trait value of a sample shellfish individual corresponding to each set of training samples. The second label may be determined by manual measurement, such as using a vernier caliper.

The trait generation layer of the shellfish identification model allows for the rapid generation of the trait value of the shellfish individual, and the trait generation layer is obtained by training with a large amount of data, which improves the accuracy and reliability of the trait value.

In some embodiments, the shellfish identification model further includes an inclination angle layer, and the inclination angle layer generates the inclination angle of the shellfish individual based on a black-and-white depth map.

The inclination angle layer is a model for determining the inclination angle of the shellfish individual. In some embodiments, the inclination angle layer is a machine learning model, e.g., a CNN model, etc.

In some embodiments, an input to the inclination angle layer 120 includes a black-and-white depth map 110, and an output of the inclination angle layer 120 includes the inclination angle of the shellfish individual 132, as shown in FIG. 13.

In some embodiments, the inclination angle layer may be obtained by training based on a large number of third training samples and third labels corresponding to the third training samples in a training methodology similar to that used for the species analysis layer.

Each set of training samples in the third training samples may include a sample black-and-white depth map. The sample black-and-white depth map may be obtained from historical scanning data of the three-dimensional laser scanner. The third label corresponding to the third training sample is an inclination angle of a sample shellfish individual corresponding to each set of training samples. The third label may be determined by manual measurement.

In some embodiments, the training of the shellfish identification model includes setting different training sets for different species of shellfish individuals; generating a plurality of fake samples through the intelligent control unit 5, and training the shellfish identification model based on training sets containing the plurality of fake samples.

In some embodiments, different training sets are set for different species of shellfish individuals. For the same species of shellfish individuals, a training set is set up, and the training set includes a first training sample and a first label corresponding to the species of shellfish individuals, a second training sample and a second label corresponding to the species of shellfish individuals, or a third training sample and a third label corresponding to the species of shellfish individuals. The species analysis layer, the inclination angle layer, and the trait generation layer of the shellfish identification model are trained through different training sets, respectively, and a specific training process is described in FIG. 13.

The fake sample is a training sample in which a species or a trait value of a shellfish individual is not accurately identified due to a change in an inclination angle of the shellfish individual. In some embodiments, the intelligent control unit 5 may randomly generate a plurality of fake samples; randomly add fake samples in different training sets, and train the species analysis layer, the inclination angle layer, and the trait generation layer of the shellfish identification model based on training sets containing the fake samples, respectively; and determine a learning rate of different layers based on a statistical value (e.g., an average) of differences between of a plurality of output results of different layers of the shellfish identification model and corresponding labels. The learning rate is inversely proportional to an average of the difference.

In some embodiments, in response to the average of the difference being greater than a convergence threshold, the intelligent control unit 5 may increase a number of fake samples, and continue training until the average of the difference is less than or equal to the convergence threshold. The average of the difference being less than or equal to the convergence threshold indicates that the model has reached a convergence state.

The shellfish identification model is easily confused and unable to accurately identify a species of a shellfish individual due to the change in the inclination angle of the shellfish individual. Adding fake samples for model training can improve the identification accuracy and reliability of the shellfish identification model.

In some embodiments, the intelligent control unit 5 is further configured to identify a dead shellfish and convey the dead shellfish through a conveyor belt to a discharge chute based on the weight and the trait value of the shellfish individual.

In some embodiments, the intelligent control unit 5 may, based on a historical weight of the shellfish individual monitored by a pressure sensor and a species of a historical shellfish individual, generate weight range information of different species of shellfish individuals in different growth periods through a preset statistical method. The preset statistical method may be a method such as clustering, statistical generalization, or the like.

In some embodiments, in response to detecting that a weight of a shellfish individual is less than a lower limit of weight range information of a shellfish individual for that species during its growth period, the intelligent control unit 5 may identify the shellfish individual as a dead shellfish.

In some embodiments, the intelligent control unit 5 may, in response to detecting that a weight of a shellfish individual is greater than an upper limit of weight range information of a shellfish individual for that species during its growth period, output a notification indicating “shellfish species identification error.”

In some embodiments, a waste collection port is provided below a discharge chute 37. The waste collection port is used to collect dead shellfish.

By identifying and expelling dead shellfish from the system, the effectiveness of data collection can be improved, preventing dead shellfish from interfering with the accuracy of the data.

In some embodiments, the intelligent control unit 5 is further configured to obtain identification information of the shellfish individual, the identification information including a historical weight and a historical trait value of the shellfish individual at a previous historical time point; generate a state discriminator marker of the shellfish individual based on the identification information, the weight and the trait value of the shellfish individual currently acquired, and the inclination angle of the shellfish individual; and update a data status of the shellfish individual.

The previous historical time point is the last time a shellfish individual is measured using a high-throughput and accurate phenotype measurement system for shellfish.

In some embodiments, the intelligent control unit 5 may, in response to the inclination angle of the shellfish individual being greater than a preset inclination angle threshold, calculate a weight change speed and a trait value change speed based on the identification information, the weight and the trait value of the shellfish individual currently acquired; in response to determining at least one of the weight change speed or the trait value change speed is less than a preset speed threshold, determine the state discriminator marker of the shellfish individual to be dead, and update the data state of the shellfish individual. The data status may include discarded data, data to be verified, etc.

In some embodiments, the intelligent control unit 5 may designate an average of weight change speeds and an average of trait value change speeds of shellfish individuals of the same species in historical data as the preset speed threshold.

Measurement errors may exist when the inclination angle of the shellfish individual is large, and re-determining whether the shellfish individual is dead based on a change rate of the weight and the trait value of the shellfish individual with respect to the previous historical time point ensures that a discrimination result of whether the shellfish individual is dead is reasonable and accurate. At the same time, it reduces the occurrence of misjudgment and improves the automation of the system.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure.

Those types of modifications, improvements, and amendments are suggested in the present disclosure, so those types of modifications, improvements, and amendments remain within the spirit and scope of the exemplary embodiments of the present disclosure.

Furthermore, the order of the processing elements and sequences, the use of numerical letters, or the use of other names described herein are not intended to limit the order of the processes and methods herein. While some embodiments of the invention that are currently considered useful are discussed in the foregoing disclosure by way of various examples, it is to be understood that such details serve illustrative purposes only. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes combine a variety of features into a single embodiment, accompanying drawings, or descriptions thereof. Rather, claimed subject matter may lie in less than all features of a single foregoing disclosed embodiment.

Some embodiments use numbers to describe the number of components, attributes, and it should be understood that such numbers used in the description of the embodiments are modified in some examples by the modifiers “about,” “approximately,” or “substantially.” Unless otherwise noted, the terms “about,” “approximately,” or “substantially” indicates that a ±20% variation in the stated number is allowed. Correspondingly, in some embodiments, the numerical parameters used in the present disclosure are approximations, which can be varied depending on the desired characteristics of the individual embodiment. In some embodiments, the numerical parameters should consider a specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, the entire contents of such patents, patent applications, disclosures, and other materials are hereby incorporated herein by reference. Application history documents that are inconsistent with or conflict with the contents of the present disclosure are excluded, as are documents (currently or hereafter appended to the present disclosure) that limit the broadest scope of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

1. A high-throughput and accurate phenotype measurement system for shellfish, comprising a body size measurement unit, a dynamic weighing unit, an information acquisition unit, an automatic sorting unit, and an intelligent control unit arranged in sequence, wherein
the body size measurement unit is configured to measure a body size of a shellfish individual,
the dynamic weighing unit is configured to measure a weight of the shellfish individual,
the automatic sorting unit is configured to sort and collect the shellfish individual based on an acquired trait measurement value,
the information acquisition unit is configured to capture and record sample information of a candidate parent, and
the intelligent control unit is configured to control the body size measurement unit, the dynamic weighing unit, the automatic sorting unit, and the information acquisition unit.

2. The system of claim 1, wherein the body size measurement unit, the dynamic weighing unit, the automatic sorting unit, the information acquisition unit, and the intelligent control unit are fixed on a base support.

3. The system of claim 1, wherein the body size measurement unit includes a first fixation device, the information acquisition unit includes a second fixation device, the first fixation device and the second fixation device are both configured with electronic control adjustment assemblies, and the intelligent control unit is configured to:
automatically adjust a height of the first fixation device and a height of the second fixation device using the electronic control adjustment assembly.

4. The system of claim 1, wherein the body size measurement unit includes a first conveyor and a three-dimensional laser scanner, one side of the first conveyor is provided with a first through-beam photoelectric sensor and a first encoder, the first through-beam photoelectric sensor and the first encoder are both connected to the three-dimensional laser scanner, and the three-dimensional laser scanner is connected to the intelligent control unit through a transmission control protocol.

5. The system of claim 4, wherein the three-dimensional laser scanner is located above the first conveyor, and a scanning direction of the three-dimensional laser scanner is aligned with a conveyor belt of the first conveyor.

6. The system of claim 4, wherein the first conveyor is configured with an automatic cleaning assembly, the automatic cleaning assembly includes a cleaning brush and a cleaning water line, and the automatic cleaning assembly is configured to clean a surface of the shellfish individual.

7. The system of claim 4, wherein the first conveyor is configured with a position correction assembly, the position correction assembly is mechanically connected to a conveyor belt of the first conveyor, the position correction assembly includes an oscillation device, and the oscillation device is configured to control stabilization of a center of gravity of the shellfish individual on the conveyor belt through vibration.

8. The system of claim 1, wherein the dynamic weighing unit includes a second conveyor and a pressure sensor, one side of the second conveyor is provided with a second through-beam photoelectric sensor that are connected to the pressure sensor, and the pressure sensor is connected to the intelligent control unit through a transmission control protocol.

9. The system of claim 1, wherein the automatic sorting unit includes a first pusher, a second pusher, and a third pusher, and the first pusher, the second pusher, and the third pusher are connected to a first air pump, a second air pump, and a third air pump, respectively;
the first air pump, the second air pump, and the third air pump are mounted on a base support and are connected to the intelligent control unit through a transmission control protocol,
the intelligent control unit is configured to control the first pusher, the second pusher, and the third pusher to push the shellfish individual that is graded into a discharge chute.

10. The system of claim 1, wherein the information acquisition unit includes a third conveyor and a barcode scanner, one side of the third conveyor is provided with a third through-beam photoelectric sensor and a third encoder, the third through-beam photoelectric sensor and the third encoder are both connected to the barcode scanner, and the barcode scanner is connected to the intelligent control unit through a transmission control protocol.

11. The system of claim 10, wherein the barcode scanner is located above the third conveyor, and a scanning direction of the barcode scanner is toward the third conveyor.

12. The system of claim 1, wherein an identification label is affixed to a surface of the shellfish individual, the identification label records information of the shellfish individual, and the information acquisition unit is further configured to:
automatically enter a body size and a weight of the shellfish individual obtained using the body size measurement unit and the dynamic weighing unit into the corresponding identification label and associatively bind the identification label to information of the shellfish individual; and
automatically read historical data and record new measurement data to continuously track, measure, and record a growth trait of the shellfish individual.

13. The system of claim 1, wherein a vibration-absorbing device is mounted below a first conveyor, a second conveyor, and a third conveyor, and the vibration-absorbing device includes a rubber gasket, a spring, and a buffer.

14. A high-throughput and accurate phenotype measurement method for shellfish, wherein the method is performed based on an intelligent control unit of a high-throughput and accurate phenotype measurement system for shellfish, wherein the system further comprises a body size measurement unit. a dynamic weighing unit, an information acquisition unit, and an automatic sorting unit. wherein the body size measurement unit is configured to measure a body size of a shellfish individual, the dynamic weighing unit is configured to measure a weight of the shellfish individual, the automatic sorting unit is configured to sort and collect the shellfish individual based on an acquired trait measurement value. the information acquisition unit is configured to capture and record sample information of a candidate parent, and the intelligent control unit is configured to control the body size measurement unit, the dynamic weighing unit, the automatic sorting unit, and the information acquisition unit; the method comprising:
controlling a conveyor belt to transfer the shellfish individual to the body size measurement unit from an input end of a first conveyor, controlling a first through-beam photoelectric sensor and a first encoder to detect a position and speed information of the shellfish individual and sending the position and the speed information to a three-dimensional laser scanner, controlling the three-dimensional laser scanner to initiate scanning of the shellfish individual, and transmitting image data obtained by the three-dimensional laser scanner to the intelligent control unit to determine a trait value of the shellfish individual based on the image data;
after completion of individual trait measurement, transferring the shellfish individual to the dynamic weighing unit, when the shellfish individual passing through a second conveyor, controlling the dynamic weighing unit to convert a pressure signal into a high-level signal and transmitting the high-level signal to the intelligent control unit to determine the weight of the shellfish individual;
when transferring the shellfish individual to the information acquisition unit using a third conveyor, scanning and identifying an identification label affixed to a surface of the shellfish individual using a barcode scanner, reading the sample information, and automatically entering the trait value and the weight of the shellfish individual into the corresponding identification label at the same time;
after the shellfish individual entering the automatic sorting unit, controlling the automatic sorting unit to determine a target individual by comparing with a preset grading standard based on the body size or the weight of the shellfish individual, controlling a first air pump, a second air pump, and a third air pump to drive a first pusher, a second pusher, and a third pusher to extend and retract, respectively, and push the target individual to a discharge chute of a corresponding grade, and completing sorting of the candidate parent; and
collecting data of each unit and summarizing, integrating, recording, calculating, and storing the data of each unit.

15. The method of claim 14, further comprising:
based on the image data, processing the image data to output a species of the shellfish individual using a species analysis layer of a shellfish identification model, the shellfish identification model being a machine learning model; and
automatically adjusting a height and a rotation angle of a first fixation device and a height and a rotation angle of a second fixation device based on the species of the shellfish individual.

16. The method of claim 15, wherein an input to the species analysis layer further includes an inclination angle of the shellfish individual.

17. The method of claim 14, further comprising:
generating the trait value of the shellfish individual based on a species of the shellfish individual, the image data, and an inclination angle of the shellfish individual using a trait generation layer of a shellfish identification model.

18. The method of claim 17, wherein training of the shellfish identification model includes:
setting different training sets for different species of shellfish individuals;
generating a plurality of fake samples through the intelligent control unit, and
training the shellfish identification model based on training sets containing the plurality of fake samples.

19. The method of claim 14, further comprising:
identifying a dead shellfish and conveying the dead shellfish through the conveyor belt to the discharge chute based on the weight and the trait value of the shellfish individual.

20. The method of claim 19, further comprising:
obtaining identification information of the shellfish individual, the identification information including a historical weight and a historical trait value of the shellfish individual at a previous historical time point;
generating a state discriminator marker of the shellfish individual based on the identification information, the weight and the trait value of the shellfish individual currently acquired, and an inclination angle of the shellfish individual; and
updating a data status of the shellfish individual.
